(19) United States
(12) Patent Application Publication
(10) Pub. No.: US 2013/0103507 A1
(43) Pub. Date: Apr. 25, 2013

(54) System and Method for Dynamically Changing Advertisements

(71) Applicant: Edward W. Mandel, Frisco, TX (US)

(72) Inventor: Edward W. Mandel, Frisco, TX (US)

(73) Assignee: NEXPLORE TECHNOLOGIES, INC., Plano, TX (US)

(21) Appl. No.: 13/527,524

(22) Filed: Jun. 19, 2012

Related U.S. Application Data
(63) Continuation of application No. 12/508,201, filed on Jul. 23, 2009, now abandoned.
Application No. 12/508,201 is a continuation-in-part of application No. 12/437,197, filed on May 7, 2009.
Application No. 12/437,197 is a continuation-in-part of application No. 12/348,653, filed on Jan. 5, 2009, now abandoned.
Application No. 12/348,653 is a continuation-in-part of application No. 12/340,195, filed on Dec. 19, 2008, now abandoned.

(51) Int. Cl. G06Q 30/02

(52) U.S. Cl. CPC G06Q 30/0277
USPC 705/14.73

(57) ABSTRACT

A system and method for providing, in a networked environment, dynamically changing advertisements in response to a user's instant messaging (IM) exchange. An IM interaction module is operably coupled with an advertisement publishing service and an IM service; a message polling module is operably coupled with the IM interaction module; and an advertisement display module is operably coupled with the message polling module and with an IM client interface. The IM client interface includes at least one area for user IM session message text and at least one area for display of one or more advertisements that are provided by the advertisement publishing service based upon the IM session message text content. Method steps include accepting an IM session request, parsing the IM text message content, requesting advertisements based upon the parsed content, and providing the received advertisements to the user's IM client interface for display.

### CROSS-REFERENCE TO RELATED APPLICATIONS

This application is a continuation of U.S. patent application Ser. No. 12/508,201, which was filed Jul. 23, 2009, which is a continuation-in-part of U.S. patent application Ser. No. 12/437,197, which was filed on May 7, 2009, and which is a continuation-in-part of U.S. patent application Ser. No. 12/348,653, which was filed on Jan. 5, 2009, and which is a continuation-in-part of U.S. patent application Ser. No. 12/340,195, which was filed on Dec. 19, 2008.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to web advertising services, and more specifically to advertisement in instant messaging systems.

2. Description of Related Art including information disclosed under 37 CFR 1.97 and 1.98

Instant messaging is ubiquitous. Windows live messenger is included with every version of Windows purchased and nearly every free e-mail service provides instant messaging capability. The more relevant advertising is to a viewer, the more likely the viewer is to purchase the product or services offered in the ad. Instant messaging clients provide a static interface for communicating with others. A few clients allow a user to instant message (IM) using different accounts, but the environment has not been leveraged to provide further ad impressions to users.

### BRIEF SUMMARY OF THE INVENTION

The present invention provides a system for providing, in a networked environment, dynamically changing advertisements in response to a user's instant messaging (IM) exchange, the system comprising: an IM interaction module that is operably coupled with an advertisement publishing service and an IM service; a message polling module that is operably coupled with the IM interaction module; and an advertisement display module that is operably coupled with the message polling module and with an IM client interface, wherein the IM client interface includes at least one area for user IM session message text and at least one area for display of one or more advertisements that are provided by the advertisement publishing service based upon the IM message text content.

The present invention also provides a method and a computer software product tangibly embodying program steps for providing, in a networked environment, dynamically changing advertisements in response to a user's instant messaging (IM) exchange, the method steps comprising: providing an IM interaction module that is operably coupled with an advertisement publishing service and an IM service; providing a message polling module that is operably coupled with the IM interaction module; providing an advertisement display module that is operably coupled with the message polling module and with an IM client interface, wherein the IM client interface includes at least one area for display of one or more advertisements; accepting from a user an IM session request; parsing the text of a message sent or received by the user; requesting one or more advertisements from the advertisement publishing service based upon the parsed message content; and providing the one or more advertisements for display within the user's IM client interface.

### BRIEF DESCRIPTION OF THE SEVERAL VIEWS OF THE DRAWING(S)

The present invention will be more fully understood by reference to the following detailed description of the preferred embodiments of the present invention when read in conjunction with the accompanying drawings, wherein:

FIG. 1 exemplifies a diagram of a dynamically changing advertisement system in a networked environment, in accordance with principles of the present invention; and

FIG. 2 exemplifies a diagram of a method for providing dynamically changing advertisements, in accordance with principles of the present invention.

The above figures are provided for the purpose of illustration and description only, and are not intended to define the limits of the disclosed invention. Use of the same reference number in multiple figures is intended to designate the same or similar parts. Furthermore, if and when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the preferred embodiment will be explained or will be within the skill of the art after the following teachings of the present invention have been read and understood.

### DETAILED DESCRIPTION OF THE INVENTION

In the following discussion, numerous specific details are set forth to provide a thorough understanding of the present invention. However, it will be obvious to those skilled in the art that the present invention may be practiced without such specific details. In other instances, well-known elements have been illustrated in schematic or block diagram form in order not to obscure the present invention in unnecessary detail. Additionally, for the most part, details concerning the Internet, digital content, and the like have been omitted inasmuch as such details are not considered necessary to obtain a complete understanding of the present invention, and arc considered to be within the skills of persons of ordinary skill in the relevant art.

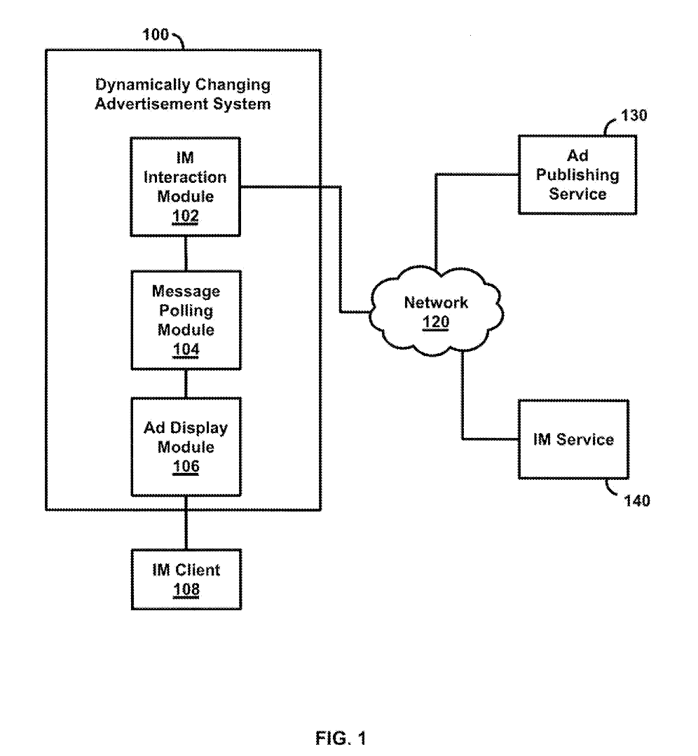

Referring to FIG. 1, there is shown a diagram of a dynamically changing advertisement system (100) for providing advertisements over a network, in accordance with principles of the present invention. The application can be resident on a computer, a website, blog, forum, aggregator, and other suitable web-enabled application. The system (100) is preferably implemented in hardware, software, or a suitable combination of hardware and software thereof and may comprise one or more software systems operating on a digital signal processing platform or other suitable processing platforms.

As used herein, “hardware” can include a combination of discrete components, an integrated circuit, a microprocessor, a controller, a microcontroller, an application-specific integrated circuit (ASIC), an electronic data processor, a computer, a field programmable gate array, or other suitable hardware connectable for interfacing with a network, such as the Internet, considered to be well-known in the art. As used herein, “software” can include one or more objects, agents, threads, lines of code, subroutines, separate software applications, two or more lines of code or other suitable software structures operating in two or more software applications or on two or more processors, or other suitable hardware structures. As used herein “computer readable medium” means any tangible portable or fixed RAM or ROM device, such as portable flash memory, a CDROM, a DVDROM, embedded RAM or ROM integrated circuit devices, or the like.

It is considered that the design, development, and implementation details of all such hardware and software would be apparent to a person having ordinary skill in the art based upon a review of the present description of the invention. In one embodiment, software can include one or more lines of code or other suitable software structures operating in a general purpose software application, such as an operating system, and one or more lines of code or other suitable software structures operating in a specific purpose software application.

The system (100) is operably coupled to an instant messaging (IM) client (108), an advertisement publishing service (130), and an IM service (140) by a computer network (120). The network can be a WAN, MAN, LAN, PAN, or other suitable network. The system (100) is adapted to display advertisements in the IM client (108) based on. IM messages that are sent and received. The system (100) in this embodiment also includes an IM interaction module (102), a message polling module (104), and an ad display module (106).

The IM interaction module (102) is adapted to provide'a user interface for logging in and instantiating a communication session with another using the IM service (140). In one embodiment, the IM interaction module (102) receives a username and a password from a user. In a second embodiment, the IM interaction module (102) receives a username and a password from a user for one or more IM services. In a third embodiment, the username and password for one or more IM services is stored in a user account. In a fourth embodiment, the user can be automatically logged into the IM service (140) when the IM client (108) is launched. In a fifth embodiment, the IM Service (140) can initiate communication for Windows Live Messenger, Gtalk, AOL Instant Messenger, Yahoo! Messenger, or other suitable IM services. The IM interaction module (102) can be achieved with an application programming interface (API), a network connection, a network transfer protocol, HTML, DHTML, Java, JavaScript, Dojo, Ruby, Rails, other suitable formats and applications, or a suitable combination thereof.

The message polling module (104) is adapted to generate an advertisement request based on the IM messages sent and received by the user. The message polling module (104) sorts the words of the messages according to occurrence. The message polling module (104) then generates an advertisement request containing the most popular word. The message polling module (104) sends the advertisement request to the ad publishing service (130). The message polling module (104) then receives the advertisement and stores it locally. In one embodiment, an XML transaction is generated having the advertisement request. In a second embodiment, a JSON transaction is generated having the advertisement request. In a third embodiment, the advertisement is received as an XML transaction. In a fourth embodiment, the advertisement is received as a JSON transaction. The message polling module (104) is initiated based on the occurrence of an event. In a fifth embodiment, the event can be the passage of a certain period of time. In a sixth embodiment, the event can be the sending or receiving of a certain number of messages, or both. The message polling module (104) can be achieved with an application programming interface (API), a network connection, a network transfer protocol, HTML, DHTML, Java, JavaScript, Dojo, Ruby, Rails, other suitable formats and applications, or a suitable combination thereof.

The ad display module (106) is adapted to display the advertisement in the IM client interface (108). In one embodiment, the ad display module (106) receives the advertisement from message polling module (104). In a second embodiment, the ad display module formats the advertisement according to user-selected settings. In a third embodiment, the ad display module (106) displays the formatted advertisement in a second area of the IM client (108). The ad display module (106) can be achieved with an application programming interface (API), a network connection, a network transfer protocol, HTML, DHTML, Java, JavaScript, Dojo, Ruby, Rails, other suitable formats and applications, or a suitable combination thereof.

In operation, the user launches an IM client interface (108) having a dynamically changing advertisement system (100). The user logs into an IM service (140) to retrieve contacts and status via IM interaction module (102). The ad display module (106) formats and displays a default advertisement in a first area of the IM client interface (108) when it is first launched. Once the user begins sending and receiving messages via network (120), the IM client (108) displays the sent and received messages in a second area of the IM Client (108). The message polling module (104) processes the messages in the second window to determine the most popular word or words. The message polling module (104) sends an advertisement request to the ad publishing service (130) and receives an advertisement from ad publishing service (130) via the network (120). The system (100) formats and displays the advertisement associated with the message content in the second area of the IM client (108) via the ad display module (106). After the occurrence of an event, such as the passage of time or the sending and receiving of a certain number of messages, the message polling module (104) again processes the messages in the second window to determine the most popular word or words. The message polling module (104) again sends an advertisement request to ad publishing service (130) and again receives an advertisement from ad publishing service (130) via network (120). The system (100) formats and displays the advertisement associated with the message content in the second area of the IM client (108) via ad display module (106). The polling module (104) re-polls the messages in this way until the IM client (108) is closed.

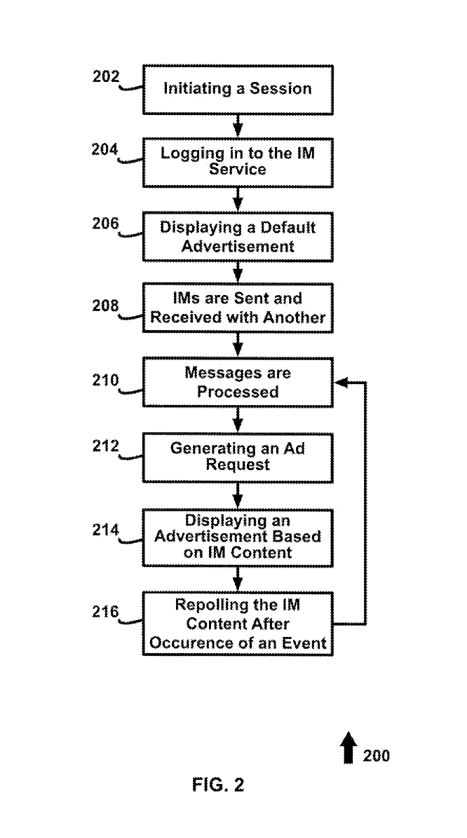

Referring now to FIG. 2, there is shown a flow chart (200) exemplifying control logic embodying features of a method for dynamically changing advertisements in accordance with principles of the present invention. The dynamically changing advertisement control logic (200) can be implemented as an algorithm on a general purpose computing platform or other suitable microprocessor-based system such as a dedicated server platform, a desktop computer, a handheld computer, a smart-phone, or the like.

The dynamic advertisement control logic (200) can leverage the ability of a computer platform to spawn multiple processes and threads by processing data simultaneously. The speed and efficiency of the dynamically changing advertisement control logic (200) is greatly improved by instantiating more than one process to display an advertisement associated with IM messages. However, one skilled in the art of programming will appreciate that use of a single processing thread may also be utilized and is within the scope of the present invention.

The dynamic advertisement control logic (200) process flow of the present embodiment begins at step 202, where an IM session is initiated by an IM client (108). In another embodiment, the IM Service (140) can initiate communication for Windows Live Messenger, Gtalk, AOL Instant Messenger, Yahoo! Messenger, or other suitable IM services. The logic then proceeds to step 204.

At step 204, the user logs into an IM service. In one embodiment, the IM session is initiated by providing a username and password to the IM service (140). In a second embodiment, the IM interaction module (102) receives a username and a password from a user for one or more IM services. In a third embodiment, the username and password for one or more IM services is stored in a user account where they are accessed to automatically initiate the IM session. In a fourth embodiment, the user can automatically be logged into the IM service (140) when the IM client (108) is launched. The logic then proceeds to step 206.

At step 206, a default advertisement is displayed in the IM client (108). In one embodiment, the advertisement is automatically requested when the IM client (108) is launched. In a second embodiment, the advertisement is received and formatted according to IM client (108) settings. The logic then proceeds to step 208.

At step 208, an IM is sent to another by the user and received by the user from another. In one embodiment, the user and the other use the same IM client (108). In a second embodiment, the user and the other use different IM clients. The logic then proceeds to step 210.

At step 210, the messages are processed after the occurrence of an event. In one embodiment, the messages are processed to determine the word or words having the highest occurrence. In a second embodiment, the messages are processed to determine the most recent word or words. In a third embodiment, the event is the passage of time. In a fourth embodiment, the event is a certain number of sent messages. In a fifth embodiment, the event is a certain number of received messages. The logic then proceeds to step 212.

At step 212, an advertisement request to ad publishing service (130) is generated and an advertisement from ad publishing service (130) is received via network (120). The message polling module (104) stores the advertisement for further processing. In one embodiment, an XML transaction is generated having the advertisement request. In a second embodiment, a JSON transaction is generated having the advertisement request. In a third embodiment, the advertisement is received as an XML transaction. In a fourth embodiment, the advertisement is received as a JSON transaction. The logic then proceeds to step 214.

At step 214, an advertisement associated with IM message content is displayed in IM client (108). In one embodiment, the advertisement is formatted and displayed in a second area of the IM client (108) via ad display module (106). The logic then proceeds to step 216.

At step 216, the polling module re-polls the messages after the occurrence of an event. The repelling of the messages and display of the advertisement continues until the IM client (108) is closed. The method then proceeds to step 210.

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. All changes, which come within the meaning and range of equivalency of the claims are therefore intended to be embraced therein. Further, the recitation of method steps does not denote a particular sequence for execution of the steps. Such method steps may therefore be performed in a sequence other than that recited unless the particular claim expressly states otherwise.

I claim:

1. A method for providing, in a networked environment, dynamically changing advertisements in response to a user's instant messaging (IM) exchange, the method steps comprising:
providing an IM interaction module that is operably coupled with an advertisement publishing service and an IM service;
providing a message polling module that is operably coupled with the IM interaction module;
providing an advertisement display module that is operably coupled with the message polling module and with an IM client interface, wherein the IM client interface includes at least one area for display of one or more advertisements;
accepting from a user an IM session request;
parsing the text of a message sent or received by the user;
requesting one or more advertisements from the advertisement publishing service based upon the parsed message content; and
providing the one or more advertisements to the user's IM client interface for display.

2. The method of claim 1, the method steps further comprising:
providing one or more advertisements for display within the IM client interface upon initiation of the IM session.

3. The method of claim 1, the method steps further comprising:
initiating an IM session based upon the user's IM session request.

4. The method of claim 1, the method steps further comprising:
selecting one or more advertisements based upon an analysis of the most popular word in the parsed message.

5. The method of claim 1, the method steps further comprising:
parsing the message text on the user's IM client interface as the user types the message.

6. The method of claim 1, the method steps further comprising:
periodically parsing the message text on the user's IM client interface.

7. The method of claim 6 wherein the period for parsing is based upon a count of the messages sent or received.

8. The method of claim 6 wherein the period for parsing is based upon a fixed period of time.

9. A system for providing, in a networked environment, dynamically changing advertisements in response to a user's instant messaging (IM) exchange, the system comprising:
an IM interaction module that is operably coupled with an advertisement publishing service and an IM service;
a message polling module that is operably coupled with the IM interaction module; and
an advertisement display module that is operably coupled with the message polling module and with an IM client interface,
wherein the IM client interface includes at least one area for user IM session message text and at least one area for display of one or more advertisements that are provided by the advertisement publishing service based upon the IM session message text.

10. The system of claim 9, wherein all modules are operable on a single computing device.

11. The system of claim 9, wherein the message polling module periodically parses the message text on the user's IM client interface and requests one or more advertisements from the advertisement publishing service based upon the IM message textual content.

12. The system of claim 11, wherein the one or more requested advertisements are based upon an analysis of the most popular word in the parsed message text content.

13. A computer software program tangibly embodied in a computer readable medium, the program including machine-readable instructions executable by a computer processor to perform a method for providing, in a networked environment, dynamically changing advertisements in response to a user's instant messaging (IM) exchange, the IM exchange occurring on the user's IM client interface, the program steps comprising:
accepting an IM session request from a user, via the user's IM client interface;
parsing the text of an IM message sent or received by the user;
requesting one or more advertisements from an advertisement publishing service based upon the parsed message content; and
providing the one or more advertisements to the user's IM client interface for display.

14. The computer software program of claim 13, the program steps further comprising:
providing one or more advertisements for display within the IM client interlace upon initiation of the IM session.

15. The computer software program of claim 13, the program steps further comprising:
initiating an IM session based upon the user's IM session request.

16. The computer software program of claim 13, the program steps further comprising:
selecting one or more advertisements based upon an analysis of the most popular word in the parsed message.

17. The computer software program of claim 13, the program steps further comprising:
parsing the message text on the user's IM client interface as the user types the message.

18. The computer software program of claim 13, the program steps further comprising:
periodically parsing the message text on the user's IM client interface.

19. The computer software program of claim 18, wherein the period for parsing is based upon a count of the messages sent or received.

20. The computer-software program of claim 18, wherein the period for parsing is based upon a fixed period of time.
